(19) United States
(12) Patent Application Publication
(10) Pub. No.: US 2013/0323132 A1
(43) Pub. Date: Dec. 5, 2013

(54) RENEWABLE BLENDED NATURAL GAS AND ROCK WOOL PRODUCTION FROM A PLASMA-BASED SYSTEM

(71) Applicants: James C. Juranitch, Ft. Lauderdale, FL (US); Thomas R. Juranitch, Delray Beach, FL (US); Richard E. Tarrant, Hillsboro, FL (US)

(72) Inventors: James C. Juranitch, Ft. Lauderdale, FL (US); Thomas R. Juranitch, Delray Beach, FL (US); Richard E. Tarrant, Hillsboro, FL (US)

(21) Appl. No.: 13/825,123

(22) PCT Filed: Sep. 19, 2011
(86) PCT No.: PCT/US11/01612

§ 371 Date: Aug. 12, 2013

Related U.S. Application Data
(60) Provisional application No. 61/403,766, filed on Sep. 20, 2010.

(51) Int. Cl. H05H 1/26

(52) U.S. Cl. CPC H05H 1/26
USPC 422/186.04; 431/2

(57) ABSTRACT

A method and system for augmenting the heat energy of a plasma torch in a gassifier using chemical energy, including the steps of injecting a fuel in the proximity of a plasma torch inside the gassifier chamber; and injecting an oxidant in the proximity of a plasma torch inside the gassifier chamber. As apparatus, an enhanced plasma gassifier arrangement is of the type that has a gassifier chamber having an electrically operated plasma torch for issuing a plasma discharge into the gassifier chamber. A fuel injection arrangement is disposed to surround the electrically operated plasma torch for injecting a fuel and an oxidant into the gassifier chamber. A natural gas inlet delivers natural gas into the gassifier chamber, thereby enhancing the temperature within the gassifier chamber.

### BACKGROUND OF THE INVENTION

1. Field of the Invention

This invention relates generally to processes and systems for augmenting the plasma heat in a plasma chamber.

2. Description of the Related Art

Plasma gasification continues to grow in popularity. To date the plasma heat source has been supplemented in a gassifier chamber with methods such as coke additive combined with loosely controlled air or oxygen injection to combust grossly existing syngas in the plasma chamber. However, emission regulations have been tightened concurrently with an increase in the cost of electricity needed to operate the plasma torch.

It is, therefore, an object of this invention to reduce both, emission from the operation of a plasma power plant and the amount of electricity needed to operate a plasma torch.

### SUMMARY OF THE INVENTION

The foregoing and other objects are achieved by this invention which provides, In accordance with a method aspect thereof, a method of producing heat via oxidation of chemical fuels in a plasma chamber. In accordance with the invention, there is provided a method of augmenting heat energy in a plasma gassifier. The method includes the steps of:

injecting a fuel in the proximity of a plasma torch inside the gassifier chamber; and

injecting an oxidant in the proximity of a plasma torch inside the gassifier chamber.

In one embodiment of this method aspect of the invention, the fuel is a liquid, and in some embodiments is a refined oil stock. In other embodiments the fuel is gaseous, and includes a selectable one or combination of natural gas, syngas, butane, propane, pentane, ethane, and other gaseous fuel.

In a practicable embodiment of the invention, the steps of injecting a fuel and injecting an oxidant include the further step of directing the fuel and the oxidant directly into a plasma stream.

The temperature within the plasma gassifier is increased by injecting natural gas.

In accordance with an apparatus aspect of the invention, there is provided an enhanced plasma gassifier arrangement of the type that has a gassifier chamber. The enhanced plasma gassifier arrangement has an electrically operated plasma torch for issuing a plasma discharge into the gassifier chamber. Also, a fuel injection arrangement is disposed in the vicinity of the electrically operated plasma torch for injecting a fuel into the gassifier chamber.

In a practicable embodiment of this apparatus aspect of the invention, the fuel injection arrangement is arranged to surround the electrically operated plasma torch. The fuel injection arrangement is configured to inject a liquid fuel into the gassifier chamber.

In some embodiments of the invention, the liquid fuel is a refined oil stock. In other embodiments, the fuel injection arrangement is configured to inject a gaseous fuel into the gassifier chamber. In such gaseous fuel embodiments, the fuel Includes a selectable one or combination of natural gas, syngas, butane, propane, pentane, ethane, and other gaseous fuel.

In still further embodiments of the invention, the fuel injected into the gassifier chamber by the fuel injection arrangement is an air/fuel mixture. The air/fuel mixture is, in some embodiments, a stoichiometric mixture. In other embodiments, however, the fuel/air ratio can be lean of stoichiometric or rich of stoichiometric, to enable control over the emission of syngas.

Control over the gasification products is enhanced by providing in some embodiments an inlet for delivering lime into the gassifier chamber. Additionally, there is provided in some embodiments a natural gas inlet for delivering natural gas into the gassifier chamber. Such natural gas enhances the temperature within the gassifier chamber.

In an advantageous embodiment, the fuel injection arrangement is configured as a sleeve arranged to surround the electrically operated plasma torch. The sleeve is provided with a plurality of circumferentially arranged channels for delivering the fuel into the gassifier chamber. In some embodiments, the fuel delivered into the gassifier chamber is advantageously directed toward the plasma discharge of the electrically operated plasma torch. This close proximity to extreme heat and ionized conditions releases up to 21% more energy than oxidizing the same fuel at ambient gas nozzle conditions. This available heat energy is used to reduce the electrical consumption of the plasma torch that converts electrical energy into plasma heat energy.

In a specific embodiment of a further apparatus aspect of the invention, there is provided an enhanced plasma gassifier arrangement of the type having a gassifier chamber, the enhanced plasma gassifier arrangement having an electrically operated plasma torch for issuing a plasma discharge into the gassifier chamber. A fuel injection arrangement is disposed in the vicinity of the electrically operated plasma torch. Additionally, an oxidant injection arrangement is disposed in the vicinity of the electrically operated plasma torch for injecting an oxidant into the gassifier chamber. The fuel injection arrangement and the oxidant injection arrangement are directed substantially toward the plasma discharge stream of the electrically operated plasma torch.

### BRIEF DESCRIPTION OF THE DRAWING

Comprehension of the invention is facilitated by reading the following detailed description, in conjunction with the annexed drawing, in which:

FIG. 1 is a simplified schematic representation of a process and system for a conventional plasma gassifier adapted to have a chemical fuel injected into a plasma chamber;

FIG. 2 is a cross section of an embodiment of a fuel injection arrangement for injecting a fuel into the plasma stream of a plasma torch; and

FIG. 3 is a simplified end view of the fuel injection arrangement of FIG. 2.

### DETAILED DESCRIPTION

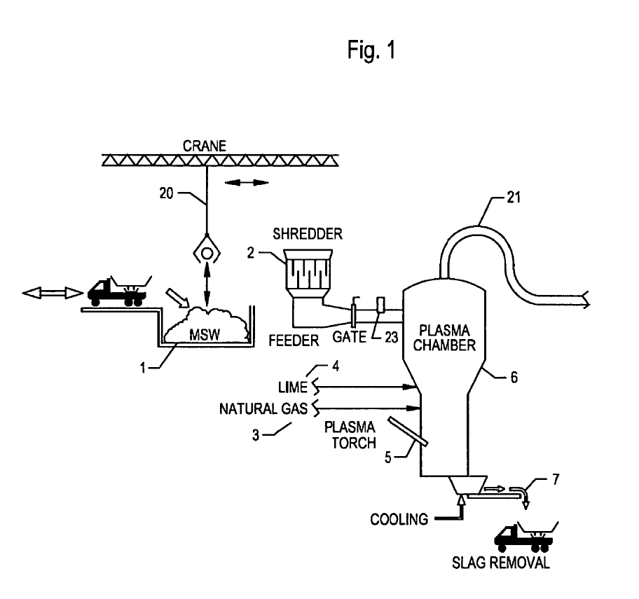

FIG. 1 is a simplified schematic representation of a process and system for a conventional plasma gassifier modified for a chemical fuel injection system constructed in accordance with the principles of the invention. As shown in this figure, MSW 1 (municipal solid waste) or other feedstock is delivered, in this specific illustrative embodiment of the invention, by a crane 20. The feedstock can be any organic material, or an inorganic mix. Crane 20 transfers MSW 1 to a shredder 2. The shredded feedstock (not shown) is then delivered to a gassifier chamber 6.

The feed system, which includes shredder 2, compresses the incoming feedstock MSW 1 so as to minimize the introduction of air. Plasma chamber 6 is advantageously operated in pyrolysis mode or in air and/or oxygen combustion boosted modes of operation. Additives such as lime 4 are added, in this embodiment, to the gassifier to control emissions and improve the quality of an output slag 7, which in this specific illustrative embodiment of the invention is removed by truck (not specifically designated).

Methods of chemically boosting heat such as with the use of oxidized natural gas at natural gas injection port 3 can be used in the practice of the invention. This fuel and oxidant are injected in the proximity of the plasma heat source within plasma chamber 6. Additionally, propane injection (not shown), or any other fuel oxidation (not shown) such as recirculated syngas, ethane, butane, pentane, oil, etc. can be used to supplement the heat input that is issued by plasma torch 5.

A syngas product is generated and transported via a syngas line 21.

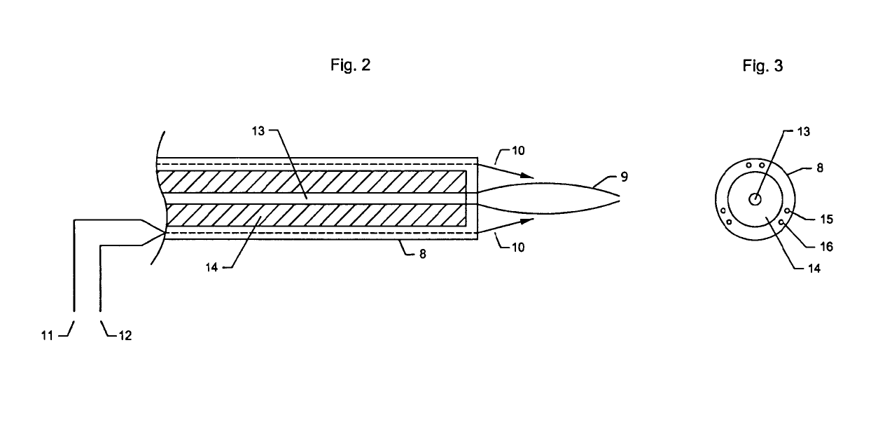

FIG. 2 and FIG. 3 show an embodiment of the invention wherein elements of structure that have previously been discussed are similarly designated. FIG. 3 is a simplified end view of the fuel injection arrangement of FIG. 2. As shown in these figures, a sleeve 8 is fitted over a plasma torch 14. Fuel and oxidant are received at respective ones of inlets 11 and 12 of plasma torch 8, and exit at fuel injection port 16 and oxidant port 15, respectively, of sleeve 8, as shown in FIG. 3. The fuel injection port and the oxidant port are replicated and distributed around the circumference of plasma stream outlet 13 of the plasma torch, also as seen in FIG. 3. Ports 15 and 16 are directed to inject the fuel and oxidant into plasma stream 9, in the directions of arrows 10 in FIG. 2. Arrows 10 are shown in this specific illustrative embodiment of the invention to be directed substantially toward plasma stream 9 of the plasma torch. In respective embodiments of the invention, the fuel/air ratio can be determined to be lean of stoichiometric, stoichiometric, or rich of stoichiometric so as to enhance control over the emission of syngas at syngas line 21 (FIG. 1).

Although the invention has been described in terms of specific embodiments and applications, persons skilled in the art may, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A method of augmenting heat energy in a plasma gassifier, the method comprising the steps of:
injecting a fuel in the proximity of a plasma torch inside the gassifier chamber; and
injecting an oxidant in the proximity of a plasma torch inside the gassifier chamber.

2. The method of claim 1, wherein the fuel is a liquid.

3. The method of claim 2 where the fuel is a refined oil stock.

4. The method of claim 1, wherein the fuel is gaseous.

5. The method of claim 4, wherein the fuel includes a selectable one or combination of natural gas, syngas, butane, propane, pentane, ethane, and other gaseous fuel.

6. The method of claim 1, wherein said steps of injecting a fuel and injecting an oxidant include the further step of directing the fuel and the oxidant directly into a plasma stream.

7. The method of claim 1, wherein there is further provided the step of injecting natural gas into the plasma gassifier.

8. An enhanced plasma gassifier arrangement of the type having a gassifier chamber, the enhanced plasma gassifier arrangement comprising:
an electrically operated plasma torch for issuing a plasma discharge into the gassifier chamber; and
a fuel injection arrangement disposed in the vicinity of said electrically operated plasma torch for injecting a fuel into the gassifier chamber.

9. The enhanced plasma gassifier arrangement of claim 8, wherein said fuel injection arrangement is arranged to surround the electrically operated plasma torch.

10. The enhanced plasma gassifier arrangement of claim 8, wherein said fuel injection arrangement is configured to inject a liquid fuel into the gassifier chamber.

11. The enhanced plasma gassifier arrangement of claim 10, wherein the liquid fuel is a refined oil stock.

12. The enhanced plasma gassifier arrangement of claim 8, wherein said fuel injection arrangement is configured to inject a gaseous fuel into the gassifier chamber.

13. The enhanced plasma gassifier arrangement of claim 12, wherein the fuel includes a selectable one or combination of natural gas, syngas, butane, propane, pentane, ethane, and other gaseous fuel.

14. The enhanced plasma gassifier arrangement of claim 8, wherein the fuel injected into the gassifier chamber by said fuel injection arrangement is an air/fuel mixture.

15. The enhanced plasma gassifier arrangement of claim 14, wherein said air/fuel mixture is a stoichiometric mixture.

16. The enhanced plasma gassifier arrangement of claim 8, wherein there is further provided an inlet for delivering lime into the gassifier chamber.

17. The enhanced plasma gassifier arrangement of claim 8, wherein said fuel injection arrangement is configured as a sleeve arranged to surround said electrically operated plasma torch.

18. The enhanced plasma gassifier arrangement of claim 17, wherein said sleeve is provided with a plurality of circumferentially arranged channels for delivering the fuel into the gassifier chamber.

19. The enhanced plasma gassifier arrangement of claim 18, wherein the fuel delivered into the gassifier chamber is directed toward the plasma discharge of said electrically operated plasma torch.

20. The enhanced plasma gassifier arrangement of claim 8, wherein there is further provided a natural gas inlet for delivering natural gas into the gassifier chamber.

21. An enhanced plasma gassifier arrangement of the type having a gassifier chamber, the enhanced plasma gassifier arrangement comprising:
an electrically operated plasma torch for issuing a plasma discharge into the gassifier chamber;
a fuel injection arrangement disposed in the vicinity of said electrically operated plasma torch for injecting a fuel into the gassifier chamber; and
an oxidant injection arrangement disposed in the vicinity of said electrically operated plasma torch for injecting an oxidant into the gassifier chamber;
wherein said fuel injection arrangement and said oxidant injection arrangement are directed substantially toward the plasma discharge of said electrically operated plasma torch.
